(19) United States
(12) Patent Application Publication
(10) Pub. No.: US 2009/0116925 A1
(43) Pub. Date: May 7, 2009

(54) Advanced logistics pallet and method of assembly and repair thereof

(75) Inventors: Vincent Juchniewicz, Berlin, CT (US); Adam Fitzgerald, East Hartford, CT (US); Stephan Parkinson, Penarth Glamorgan (GB)

Correspondence Address: HATFIELD LEGAL GROUP, LLC, 31 Water Street, Mystic, CT, 06355, US

(73) Assignee: CAPEWELL COMPONENTS CO. LLC, South Windsor, CT (US)

(21) Appl. No.: 11/983,343

(22) Filed: Nov. 7, 2007

(51) Int. Cl. B64D 9/00

(52) U.S. Cl. 410/52

(57) ABSTRACT

An aerial delivery device which includes a frame, a top skin, a bottom skin, and a core associated with the top skin, and bottom skin. The core includes a spatial arrangement of, for example, geometric cells, having a cavity defined by walls which extend at least partially between the top skin and the bottom skin. A frame that provides a substantially contiguous boarder around a perimeter of the core may be included. The present invention includes a method of assembly, maintenance, and/or repair of an aerial delivery device, wherein a top skin, a bottom skin, an aerial delivery device frame, and/or additional parts associated with aerial delivery, are associated with one another and/or the core material or replacement core material and device elements.

### FIELD OF THE INVENTION

The invention generally relates to air delivery equipment and methodology. In particular, the invention relates to an aerial delivery device, a method of its assembly, and a method of its repair and/or maintenance.

### BACKGROUND OF THE INVENTION

The transportation of cargo in both the worldwide civilian and military settings has historically been fraught with difficulty and peril. Cargo destined for geographically remote areas traditionally had to be transferred between various, and disparate modes of transport. For example, a cargo item destined for another continent often had to be shifted from wheeled conveyances to sailing vessel cargo holds and finally back to wheeled conveyances in order to be delivered to the final destination. With the advent of aircraft capable of carrying cargo, the transportation of cargo took on a new dimension which also added to the already complex logistical hurdles facing the cargo transportation industry.

Recently, the concept of intermodalism has been implemented to alleviate some of the logistical hurdles. Intermodalism employs cargo packaging with associated units that have dimensions and/or handling characteristics that can be readily integrated into transportation infrastructure. In the area of aviation, both the worldwide military and civilian markets have implemented cargo handling system intended to reduce aircraft ground time, load aircraft more fully, and increase efficiency of cargo ground handling. One part of this cargo handling system is the use of a standardized cargo pallet. For example, in one orientation the standardized pallet fits on the rollers of an aircraft such as the C-130 and C-141, and in a second orientation, the pallet fits onto/into ground transportation cargo spaces or storage bays.

The conventional standardized pallet, for both worldwide civilian and military applications, is typically constructed using a balsa wood core that is covered with corrosion-resistant aluminum. Framing the four sides of the pallet are aluminum rails which have tie-down rings attached. Cargo is usually associated with the pallet such that the cargo rests on top of the pallet and is secured to the pallet via rope or netting that is associated with the tie-down rings. In use, the side rails are typically used guide the pallet into the aircraft, and function to provide lateral and vertical restraint of the pallet and its associated cargo. The rails are often aluminum rails which have notches that can accept rail locks when the pallet is put on an aircraft. For example, the C-130 and C-141 aircraft are often fitted with a cargo rail system. The cargo rail systems incorporates rail locks to lock the pallet in place, thus preventing forward and aft movement of the pallet and associated cargo along the cargo rail while the aircraft is in flight.

Conventional pallets suffer from numerous serious limitations. For example, the balsa core, being a wood product, is subject to various international import/export regulations which severely limit the ability to reuse pallets after deployment abroad. In addition, the balsa core will expand when exposed to moisture. This expansion causes the cargo pallet to fail structurally. Furthermore, the balsa core is known to suffer damage from biological organisms such as mold, bacteria, and insects which degrade it or create health risks.

### SUMMARY OF THE INVENTION

Briefly stated, the present invention in a preferred embodiment is an aerial delivery device in the form of, for example, an advanced logistics pallet. The aerial delivery device may include a frame, a top skin, a bottom skin; and a core associated with the top skin, and bottom skin. The core may include a geometric arrangement of cells, the cells having a cavity defined by walls which extend at least partially between the top skin and the bottom skin. The top skin and a bottom skin may be approximately equally spatially separated from one another by core material having advantageous properties. The frame may include associated rail elements advantageously configured for use with aerial delivery infrastructure. Advantageous core properties may include, among other things, a relatively light weight; a high relative structural rigidity in combination with a high relative impact resistance; a high relative resistance to moisture uptake and/or liquid retention, and/or a high relative resistance to physical breakdown by insect, microbial, and environmental agents. These properties alone or in various combinations result in the inventive aerial delivery device having unexpected structural and/or load bearing characteristics, in combination with an unexpected dimensional resilience heretofore unachieved in the field. For example, unexpected structural and/or load bearing characteristics, in combination with unexpected dimensional resilience may include deployment of the inventive aerial delivery device with minimal loss of its structural integrity in an environment that includes relatively high temperature variations, relatively drastic atmospheric pressure differentials, relatively high energy impacts, relatively severe compression, tension, and/or tortional forces, and/or loads of approximately 10,000 pounds or greater within the confines of a surface that is defined by, for example, the dimensions of approximately 82 inches wide by 102 inches long.

One preferred embodiment of the present invention is an aerial delivery device which includes a core having a plurality of geometric cavities defined by a wall. The wall extends in a substantially perpendicular direction relative to a top skin and a bottom skin. The aerial delivery device includes a frame providing a substantially contiguous boarder around a perimeter of the core. An association is present between portions of the top skin, the bottom skin, the frame, and the core.

One aspect of the present invention also includes a method of assembly of an aerial delivery device, wherein a top skin, a bottom skin, an aerial delivery device frame, and additional parts associated with aerial delivery, are associated with one another and/or a core which may include a geometric tessellation, to form an aerial delivery device.

One aspect of the present invention also includes a method of repair of an aerial delivery device, wherein damage to a top skin; a bottom skin; an aerial delivery device frame; a core; and/or additional aerial delivery device elements, are repaired and/or replaced.

An object of the invention is to provide an aerial delivery device and a method of assembly and/or repair which advantageously allows for effective and desirable aerial delivery device deployment in an aerial delivery environment.

An object of the invention is also to produce a relatively low cost, efficient, and reliable aerial delivery device, method of assembling an aerial delivery device, and a method of repairing an aerial delivery device.

### BRIEF DESCRIPTION OF THE DRAWINGS

Other objects and advantages of the invention will be evident to one of ordinary skill in the art from the following detailed description with reference to the accompanying drawings, in which:

FIG. 1 is an exploded view of an aerial delivery device consistent with the present invention;

FIGS. 1A is a cut away view of a portion of an aerial delivery device consistent with the present invention;

FIG. 1B is a perspective view of an angle brace that may be used with an aerial delivery device consistent with the present invention;

FIGS. 1C and 1D are side and top views, respectively, of a support strut that may be used with an aerial delivery device consistent with the present invention;

FIGS. 2A and 2B show, respectively, hexagonal geometric cells in an arrangement and individually which may be used with an aerial delivery device consistent with the present invention;

FIGS. 2C and 2D show, respectively, triangular geometric cells in an arrangement and individually which may be used with an aerial delivery device consistent with the present invention;

FIGS. 2E and 2F show, respectively, cylindrical geometric cells in an arrangement and individually which may be used with an aerial delivery device consistent with the present invention;

FIG. 2G show geometric cells associated with material that may be used with an aerial delivery device consistent with the present invention;

FIGS. 3A-3E show various portions, arrangements, and relationships of core elements and/or associated material that may be used with an aerial delivery device consistent with the present invention;

FIG. 4 is a side view of a portion of an aerial delivery device consistent with the present invention;

FIG. 4A is a perspective view of an angle clip that may be used with an aerial delivery device consistent with the present invention;

FIG. 5 is an exploded view of a portion of an aerial delivery device consistent with the present invention;

FIG. 6 is a top view of a portion of a portion of an aerial delivery device consistent with the present invention;

FIG. 7 is side view of a portion of an aerial delivery device consistent with the present invention;

FIG. 8 is a cut-away view of a portion of a side rail and associated elements that may be used with an aerial delivery device consistent with the present invention;

FIG. 9 is a cut-away view of a portion of an end rail and associated elements that may be used with an aerial delivery device consistent with the present invention;

FIG. 10 is an isometric view of an aerial delivery device and associated load “L” consistent with the present invention;

FIG. 11 shows various steps that may be used in assembling an aerial delivery device consistent with the present invention;

FIG. 12 shows a step that may be used in assembling an aerial delivery device consistent with the present invention;

FIG. 13 shows a step that may be used in assembling an aerial delivery device consistent with the present invention;

FIG. 14 shows various steps that may be used in assembling an aerial delivery device consistent with the present invention;

FIG. 15 shows various steps that may be used in assembling an aerial delivery device consistent with the present invention;

FIG. 16 shows various steps that may be used in assembling an aerial delivery device consistent with the present invention;

FIG. 17 includes a step that may be used in assembling an aerial delivery device consistent with the present invention;

FIG. 18 includes a step that may be used in assembling an aerial delivery device consistent with the present invention;

FIG. 19 includes a step that may be used in assembling an aerial delivery device consistent with the present invention;

FIG. 20 includes various steps that may be used in maintaining and/or repairing a top skin and/or core of an aerial delivery device consistent with the present invention;

FIG. 21 includes various steps that may be used in maintaining and/or repairing a bottom skin and/or core of an aerial delivery device consistent with the present invention;

FIG. 22 is a cut away view of a portion of an aerial delivery device which includes a modified portion consistent with the present invention; and

FIG. 23 is a cut away view of a portion of an aerial delivery device which includes a modified portion consistent with the present invention.

### DESCRIPTION OF THE PREFERRED EMBODIMENT

With reference to the drawings wherein like numerals represent like parts throughout the several figures, an aerial delivery device in accordance with the present invention is generally designated by the numeral 10.

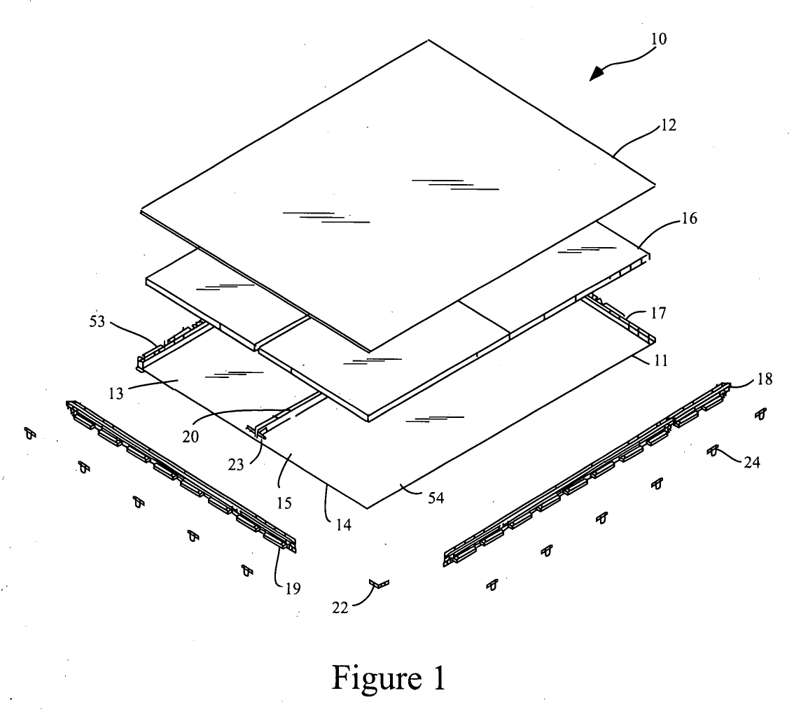

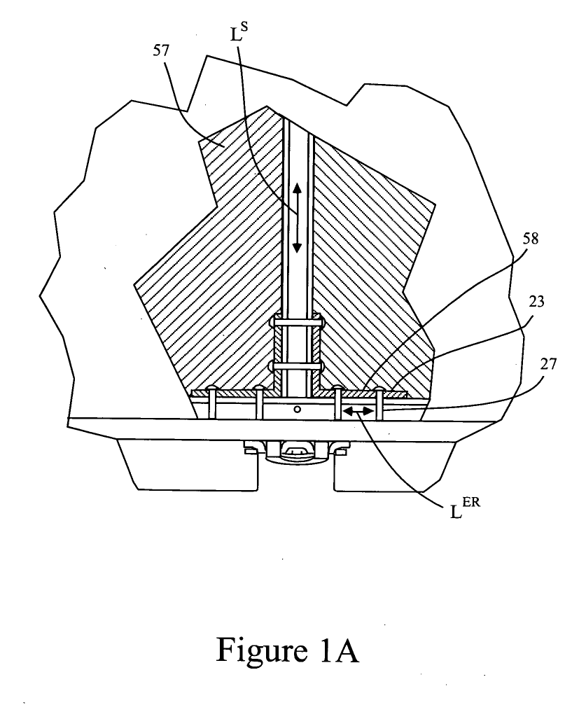

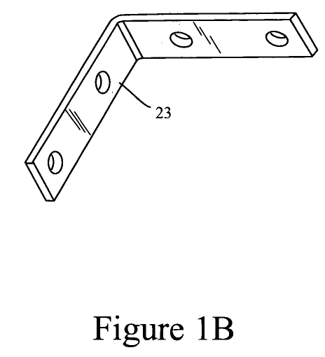

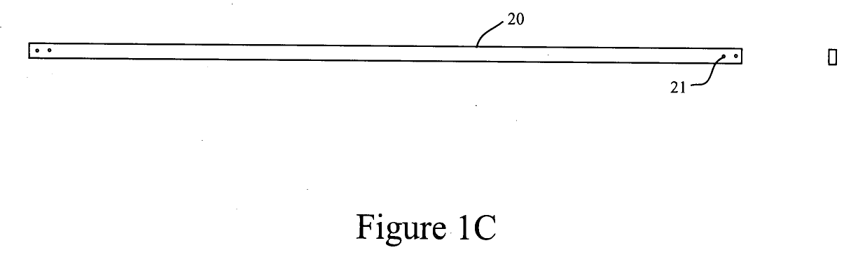

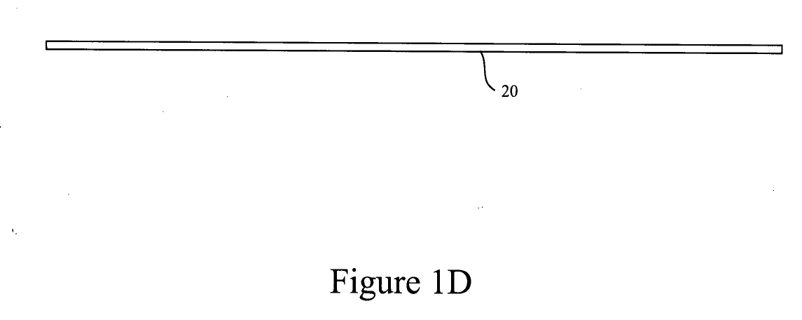

In one embodiment of the present invention, as shown in FIG. 1, the aerial delivery device 10 includes a first device side 11, a second device side 13, a first device end 15, a second device end 17, an upper or top skin 12, a lower or bottom skin 14, a core 16, an side rail 18, and an end rail 19. In one embodiment of the present invention, the core 16 is associated with at least one support strut 20, and the side rail 18 and/or the end rail 19 may be associated by an angle clip 22 and may have associated tie down rings 24. The support strut 20 may be associated with the side rail 18 and/or the end rail 19 by, for example, the support strut 20 extending from the end rail 19 at the first device end 15 to the rail 19 at the second device end 17.

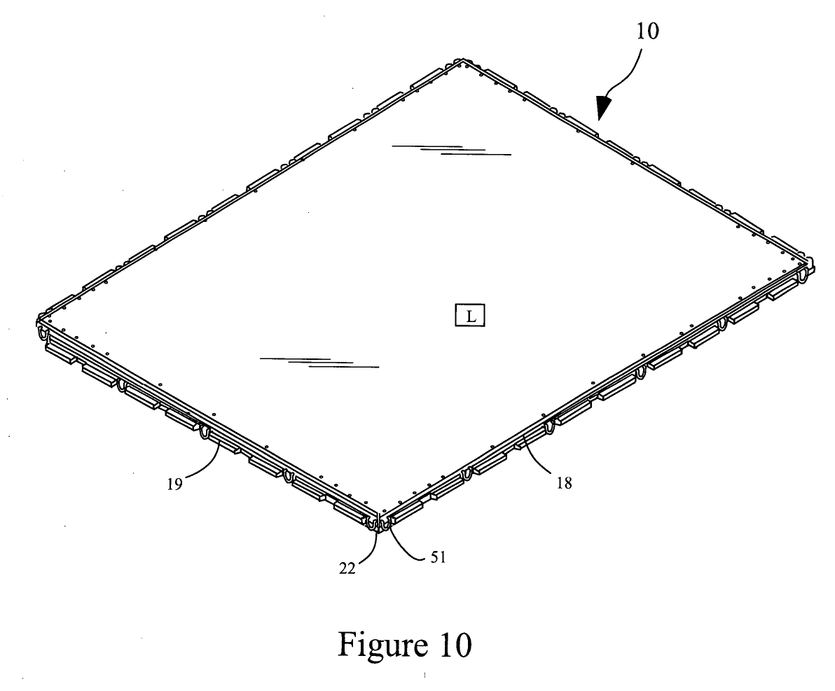

In one embodiment of the present invention, an associated pair of side rails 18 and a pair of end rails 19 comprises an aerial delivery device frame 51(FIG. 10). The pair of side rails 18 and pair of end rails 19 may be associated with one another by weld material, adhesive material, and/or other material which advantageously associates the rail pairs together. In addition, the side rails 18 and end rails 19 may be associated with one another by mechanical engagement between each rail. For example, an end rail 19 may have a surface that interlocks with a surface of a side rail 18 such that the rails are associated with one another. This mechanical interaction may be supplemented by, for example, weld material, adhesive material, and/or other material which advantageously associates the rail pairs together.

In one embodiment of the present invention, the side rails 18 and end rails 19 form a substantially contiguous boarder around a perimeter of the core 58 (FIG. 1A).

An embodiment of the present invention includes an aerial delivery device frame 51 (FIG. 10) which may be formed from a contiguous material. The aerial delivery device frame 51 (FIG. 10) may include plastics, synthetic and/or natural fibers, fabrics, resins, polymers, metals, ceramics, glasses, composites and/or other materials which provide advantageous load bearing and/or resilient properties in an aerial delivery environment. For example, the associated pair of side rails 18 and pair of end rails 19 may be formed from aluminum and/or carbon fiber composite.

In one embodiment of the present invention, the support strut 20 extends between the end rail 19, at the first device end 15, and the end rail 19, at the second device end 17. The support strut 20 may be associated with the rail 19, as shown in FIG. 1A, by at least one angle brace 23 (FIG. 1B) and brace fasteners 27. The support strut 20 may be entirely within an interior 57 of the aerial delivery device as shown in, for example, FIG. 1A. The brace fasteners 27 may be screws, rivets, adhesives, weld material, and/or the like. The support strut 20 may be positioned such that when associated with the end rail 19 a substantially 90 degree angle is formed, as shown in FIG. 1A, relative to the longitudinal axis “L^{S}” of the support strut 20 and the longitudinal axis “L^{ER}” of the end rail 19. It should be understood that other configurations may be utilized. For example, multiple support struts 20 may be included which extend substantially between the end rails 19 and the side rails 18. In addition, support struts 20 may be utilized which attached to rails 18, 19 and to one or more other support struts 20 forming, for example, a grid pattern.

In one embodiment of the present invention, the support strut 20 provides advantageous physical properties to the aerial delivery device 10. For example, the support strut 20 may provide advantageous longitudinal support such that the aerial delivery device may support loads placed on its surface. The support strut 20 may also eliminate or reduce aerial delivery device damage or integrity loss occurring through flexure, warping, skin delamination, skin wrinkling, core deformation or damage, and/or device buckling when a loaded or partially loaded aerial delivery device is, for example, lifted from the first device end 15 and/or the second device end 17 or by tie down rings 24. The support strut 20 may be configured in, for example, a tubular form having a substantially round, oval, square, or rectangular shape, or may be formed in a substantially solid rectangular, “I”, “L” or “T” configuration. For example, the support strut 20 may have a solid I-beam configuration. The support strut 20 may be formed from, for example, plastics, synthetic and/or natural fibers, fabrics, resins, polymers, metals, ceramics, glasses, composites and/or other materials which provide advantageous load bearing and/or resilient properties in an aerial delivery environment.

In one embodiment of the present invention, as shown in FIGS. 1C and 1D, the support strut 20 is an elongate rectangular structure having at least one surface 21 which aids in associating the support strut 20 with the aerial delivery device.

In one embodiment of the present invention, the support strut 20 may be formed of, or incorporate, aluminum alloy, for example 6061-T6, per ASTM B221, or 6005-T5 per ASTM B221. The support strut 20 may be tubular and have dimensions, for example, of approximately 100.88 inches long, approximately 1.00 inch wide, and approximately 1.97 inches in height, and have wall thicknesses between approximately 0.110 inches and approximately 0.125 inches.

In one embodiment of the present invention, as shown in FIG. 1, the upper skin 12 and/or the lower skin 14 may be formed of, or incorporate plastic, synthetic and/or natural fibers, fabrics, resins, polymers, metals, ceramics, glasses, composites, and/or other materials which provide or synergistically contribute to advantageous mechanical properties desirable for an aerial delivery device. For example, the upper skin 12 and/or the lower skin 14 may be formed of aluminum, fiberglass, and/or fiber composites such that the upper skin 12 and/or the lower skin 14 is resistant to impact and breakages and yet include advantageous characteristics with respect to applied pressure, bending, torsion, and other forces present in an aerial delivery deployment environment.

In one embodiment of the present invention, the upper skin 12 and/or the lower skin 14 may be formed of, or incorporate, aluminum alloy, for example 6061-T6 having a approximate thickness of 0.063 inches and a dimension of approximately 102.81 inches long by approximately 82.81 inches wide.

In one embodiment of the present invention, the core 16 may be formed from one or more pieces. For example, the core 16 may be formed from at least two pieces which are distributed on a first side 53 of the aerial delivery device, and a second side 54 of the aerial delivery device as, for example, defined by and/or relative to the position of the support strut 20.

In one embodiment of the invention, the core 16 is formed of natural and/or synthetic material comprising, for example, an arrangement of geometric cells having a wall that extends or partially extends the distance defined between the top skin 12 and the bottom skin 14. For example, the core 16 may include material arranged in a geometric tessellation such as a honeycomb and/or materials having a series of adjacent geometric cells each cell having an open space architecture defined by cell walls which extend at least partially between a top skin surface and a bottom skin surface of the aerial delivery device.

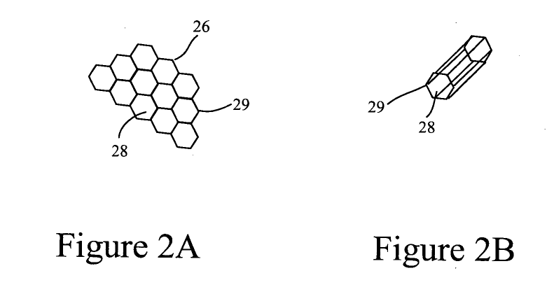

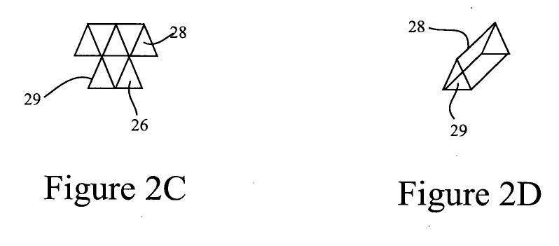

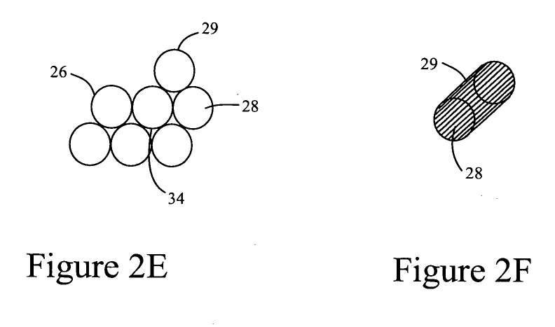

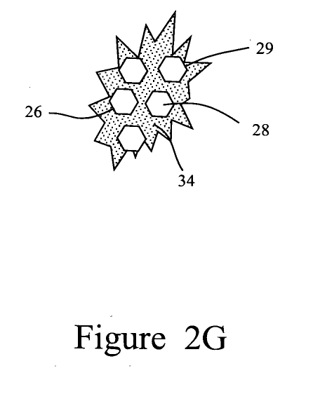

In one embodiment of the present invention, a portion of the core 16 is formed of a metal, for example, aluminum, or a synthetic material, for example, Nomex®. The core 16 may be formed such that it includes a hexagonal (FIG. 2A) configuration. The hexagonal configuration may be achieved, for example, by providing walls 29 that form a cavity 28 that defines a hexagonal shape. The walls 29 may be dimensioned such that the cavity 28 has an advantageous size, for example, depth (FIG. 2B). In one embodiment of the present invention, the walls 29 may be dimensioned such that the cavity 28 extends substantially the entire distance between the top skin 12 and the bottom skin 14.

The core 16, in one embodiment of the present invention, as may be shown in FIGS. 2A-2G, includes at least one geometric tessellation having cavities 28 defined by walls 29. For example, the core 16 may include polygonal and/or other geometric cells 26 having, as way of illustration, a substantially central cavity 28, defined by a wall 29. The cells may be substantially hexagonal (FIGS. 2A, 2B), triangular (FIGS. 2C, 2D), round (FIGS. 2E, 2F), square, rectangular, pentagonal, or octagonal. It should be understood that the cells 26 may be non-tessellate and/or may contain other geometric and polygonal shapes, or combinations of the same, and may be combined to form a tessellate, for example, an arrangement of octagonal and square cells. The cells 26 may be arranged such that the walls 29 of each of the cells 26 is in substantial contact with surrounding cells 26 as shown illustratively in FIGS. 2A, 2C, 2E and 2G. As shown illustratively in FIGS. 2E and 2G the walls 29 of each of the cells 26 may include interstitial material 34. The interstitial material 34 may be present between all, a portion of, or select regions of the cells 26 and may, for example, be utilized to advantageously modify mechanical stability and/or rigidity of the core 16 and/or the load capacity of the core 16 or regions of the core 16. The interstitial material 34 may include such things as voids, fibers, sheets, mesh, gas, foam, liquid, solids, and/or gels.

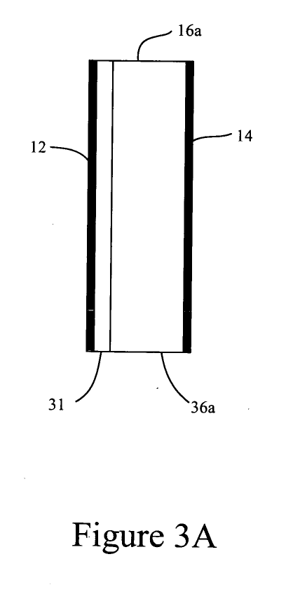

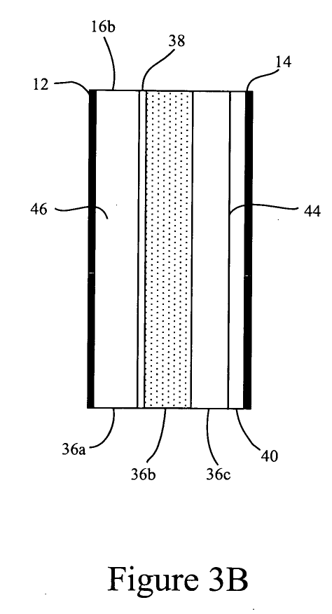

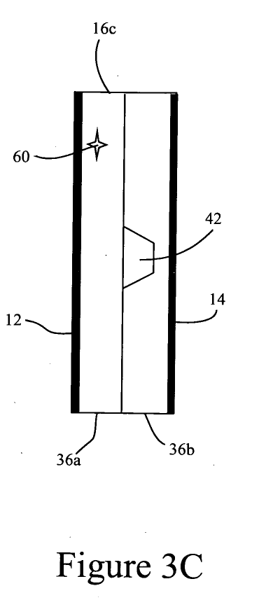

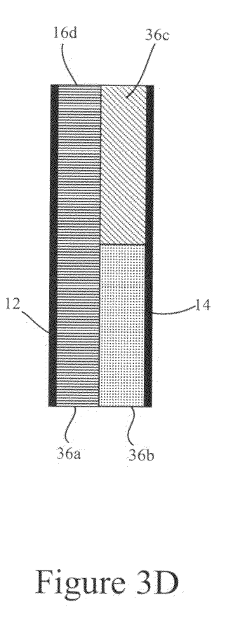

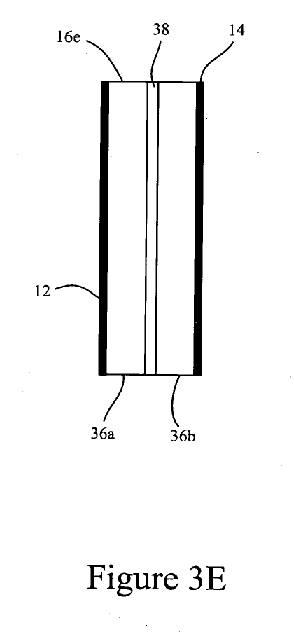

In one embodiment of the present invention, as shown in FIGS. 3A-3E the core 16A, 16B, 16C, 16D and/or 16E may include and/or be associated with features such as, for example, scrim, layers, sections, composites, inclusions and/or the like. These associated features may allow and/or cooperate to provide, for example, advantageous physical properties to the core. In addition, the features may, for example, provide for efficient assembly, maintenance, and/or repair of the aerial delivery device. It should be noted that the core 16, 16A, 16B, 16C, 16D and/or 16E may include, for example, aluminum honeycomb, FRP honeycomb, Nomex® honeycomb, Recycled plastic foam, or Carbon fiber composite honeycomb such that it may include the properties of: a relatively low density; a relatively high shear strength; a relatively high compressive strength; a relatively easy bondability; a relatively imperviousness to water; fire retardant properties; and/or a relatively good environmental resistance.

In one embodiment of the present invention, the core 16, 16A, 16B, 16C, 16D and/or 16E may include a plurality of geometric cavities defined by wall 29 (FIGS. 2A-2G), said walls 29 extend in a substantially uniform direction, for example, a parallel direction relative to a top skin and a bottom skin (FIGS. 3A-3E).

In one embodiment of the present invention, as shown in FIG. 3A, the core 16A includes a first core element 36A and an associated scrim 31. For example, the first core element 36A may be a polypropylene honeycomb and the associated scrim 31 may include polyester. The first core element 36A and the scrim 31 may be associated by bonding, adhesion, stitching, and/or other associative techniques. In one embodiment of the present invention, the core 16A has, for example, an approximate nominal thickness of between 1.5 inches and 3.5 inches. For example, the core may have an approximate nominal thickness of 1.97 inches with a density of approximately 6.5-6.9 pounds per cubic foot.

In one embodiment of the present invention, the scrim 31 may be approximately 0.10 to 0.50 inches in thickness. For example, the scrim 31 may be approximately 0.25 inches thick.

In one embodiment of the present invention, the scrim 31 may, for example, advantageously allow for association of the core 16A with the top skin 12 via enhancement of adhesive bonding through provision of, for example, a greater surface area and/or chemically advantageous bond environments.

In one embodiment of the present invention, as shown, for example, in FIG. 3B, the core 16B may include a first core element 36A, a second core element 36B, and a third core element 36C. The core 16B may also, for example, include an internal layer 38 and/or an external layer 40. Core elements 36A, 36B, and/or 36C may include, for example, plastics, synthetic and/or natural fibers, fabrics, resins, polymers, metals, ceramics, glasses, composites and/or other materials which provide advantageous properties in an aerial delivery environment. In addition, the core elements 36A, 36B, and/or 36C may be formed of a same, similar, or different composition, and may also include the same, similar, or different geometric tessellation and/or cell arrangement.

In one embodiment of the present invention, the internal layer 38 and/or the external layer 40 are selected to advantageously modify the mechanical characteristics of the core 16B. For example, and external layer 40 may be associated with portions of the bottom surface 44 of the core 16B such that the lower skin 14 is reinforced and/or supported in areas that are expected to receive loading pressure from, for example, roller assemblies, lifting devices, dunnage material, and/or the like. It should be understood that the external layer 40 may also, or independently be positioned between the core element 36A and the upper skin 12.

The external layer 40, in one embodiment of the present invention, may be formed of, or incorporate plastic, synthetic and/or natural fibers, fabrics, resins, polymers, metals, ceramics, glasses, composites, and/or other materials which provide or synergistically contribute to advantageous mechanical properties desirable for an aerial delivery device.

The external layer 40, in one embodiment of the present invention, may be included with the core 16, 16A, 16B, 16C, 16D, 16E such that it advantageously allows association of the upper skin 12 and/or the lower skin 14 with the core 16, 16A, 16B, 16C, 16D, 16E. For example, the external layer 40 may be bonded, fused, adhered, or otherwise associated to portions of the core 16, 16A, 16B, 16C, 16D, 16E such that it provides an advantageous surface to associate the upper skin 12 and/or the lower skin 14. This advantageous surface may include a substantially continuous planar surface that includes porosity or other characteristics that allow for adhesive bonding to the upper skin 12 and/or the lower skin 14 as well as to portions of the core 16, 16A, 16B, 16C, 16D, 16E. For example, a structural adhesive such as natural and/or synthetic based structural acrylic adhesives, epoxy adhesives, urethane adhesives, vinyl ester resins may be applied to the external layer 40 such that it may be associated with the upper skin 12.

In one embodiment of the present invention, the associative adhesive is an MMA type, a polyurethane; a two step acrylic type, an epoxy type, and/or contains acrybond methyl methacrylate, for example, Loctite® H8600, or is another structural adhesive, which is utilized to associate the upper skin 12 and/or the lower skin 14 with the core 16, 16A, 16B, 16C, 16D, 16E and/or with the external layer 40. Desirable properties of an adhesive for use with an embodiment of the present invention include: a relatively high strength (shear, peel and impact), an ability to bond varying substrates, including plastic to metal; an ability to fill gaps (non-sagging), curing at approximately room temperature; need for minimal surface preparation, and/or an environmental resistance.

In one embodiment of the present invention, the external layer 40 and/or the internal layer 38 may include a thermoplastic films which aid in associating the core with the skin and/or associating any of the core element 36A, 36B, 36C to any other of the core elements 36A, 36B, 36C.

In one embodiment of the present invention, the internal layer 38, as shown in FIGS. 3B and 3E may be associated with the core 16B, 16E such that the internal layer 38 is located intermediate portions of the first core element 36A and the second core element 36B. The internal layer 38 when associated with the first core element 36A and the second core element 36B provide, in one embodiment of the present invention, advantageous physical properties to the core 16B, 16E. For example, the internal layer 38 may provide longitudinal torsional and/or lateral stability to a core 16B, 16E such that, for example, a support strut 20 (FIG. 1) is not needed, or has a modified configuration.

The internal layer 38, in one embodiment of the present invention, may be formed of, or incorporate plastic, synthetic and/or natural fibers, fabrics, resins, polymers, metals, ceramics, glasses, composites, and/or other materials which provide or synergistically contribute to advantageous mechanical properties desirable for an aerial delivery device. For example, the internal layer 38 may include carbon fiber, aramid fiber, polyethylene-based fibers such as Spectra® fiber and/or various arrangements of graphite fiber mesh, woven fiber assemblies and/or non-woven fiber assemblies.

In one embodiment of the present invention, the mechanical characteristics of the core 16, 16A, 16B, 16C, 16D, 16E may be influenced by, for example, physical properties of the core 16, 16A, 16B, 16C, 16D, 16E materials; geometric cell wall 29 thickness; size of the geometric cells 26; presence or composition of interstitial material 34; core 16, 16A, 16B, 16C, 16D, 16E thickness; and/or the presence of, the thickness of, the material type used, and association configuration of the external layer 40 and/or internal layer 38 associated with the core 16, 16A, 16B, 16C, 16D, 16E.

In one embodiment of the present invention, as shown in FIGS. 3A-3E a first core element 36A, a second core element 36B, a third core element 36C, and/or any scrim, sections, composites, inclusions and/or other like features may be associated with one another by, for example, stitching, adhesives, adhesive films, thermal bonding, and/or other means which allow for association between core elements and other aerial delivery device features.

In one embodiment of the present invention, as shown in FIG. 3D, the core 16D includes a first core element 36A having only one of its two faces associated with a second core element 36B and a third core element 36C. For example, the first core element 36A has one face associated with, for example, the upper skin 12 and a second face associated with at least the second core element 36B and the third core element 36C. For example, the second core element 36B and the third core element 36C may be arranged side-by-side to one another. The second core element 36B and the third core element 36C may be associated with, for example the lower skin 14.

In one embodiment of the present invention, the second core element 36B and the third core element 36C may be chosen for their advantageous physical characteristics. For example, the third core element 36C may have impact and/or deformation characteristics that prevent or reduce damage from aerial delivery and transportation equipment and features such as rollers, lift forks and/or dunnage, while the second core element 36B has, for example, advantageous rigidity characteristics. As another example, the second core element 36B may have structural characteristics that allow the aerial delivery device to have desirable load capacities, wherein, the third core element 36C may provide advantageous longitudinal support such that the aerial delivery device may support relatively heavy or dense materials placed on the top skin.

In one embodiment of the present invention, advantageous positioning of, for example, the third core element 36C within the core may also eliminate or reduce aerial delivery device flexure, warping, skin delamination, skin wrinkling, and/or buckling when a loaded or partially loaded aerial delivery device is, for example, lifted from the first device end 15 and/or the second device end 17. The third core element 36C like the first core element 36A and second core element 36B may include geometric tessellations such as, for example, a hexagonal honeycomb. The third core element 36C may include, for example, plastics, synthetic and/or natural fibers, fabrics, resins, polymers, metals, ceramics, glasses, composites and/or other materials which provide advantageous load bearing, light weight, moisture resistant, structural and/or resilient properties desirable in aerial delivery equipment.

In one embodiment of the present invention, as shown in FIG. 3C, the second core element 36C includes a structural element 42. The structural element may be associated with the, for example, the second core element 36B. Among other things, the structural element 42 may operate to modify the structural characteristics of the core 16C to allow the aerial delivery device to have specific desirable load capacities. For example, structural element 42 may provide advantageous support such that the aerial delivery device may support relatively dense materials placed on its surface. Advantageous positioning of the structural element 42 may also eliminate or reduce aerial delivery device damage such as, for example, flexure, warping, skin delamination, skin wrinkling, core compression, core damage, and/or device and/or skin buckling when a loaded or partially loaded aerial delivery device is, for example, entirely lifted or supported above a ground surface by the first device end 15 and/or the second device end 17. The structural element 42 may extend longitudinally, laterally, and/or diagonally between the side rails and/or end rails of the aerial delivery device. The structural element 42 may be advantageously configured in, for example, geometric shapes and may include hollow and/or partially hollow portions. The structural element 42 may include, for example, plastics, synthetic and/or natural fibers, fabrics, resins, polymers, metals, ceramics, glasses, composites and/or other materials which provide advantageous load bearing, light weight, moisture resistant, structural and/or resilient properties in an aerial delivery environment.

In one embodiment of the present invention the core 16, 16A, 16B, 16C, 16D, 16E may be associated with, for example, as shown in FIG. 3C, an radio frequency identification (RFID) element 60. The RFID element 60 may be active or passive and may operate to allow for aerial delivery device accountability in, for example, inventory and/or deployment assessment. It should be understood that the RFID element 60 may be associated with other external and/or internal portions of the aerial delivery pallet as determined to be advantageous.

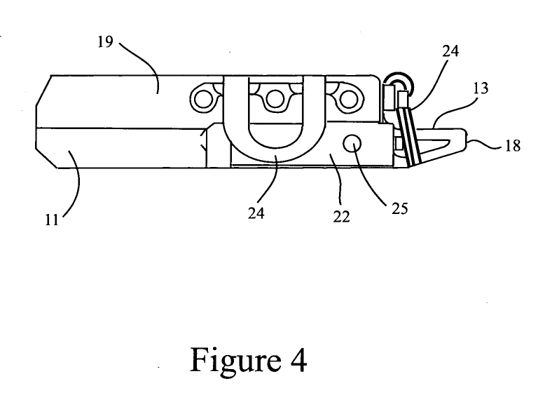

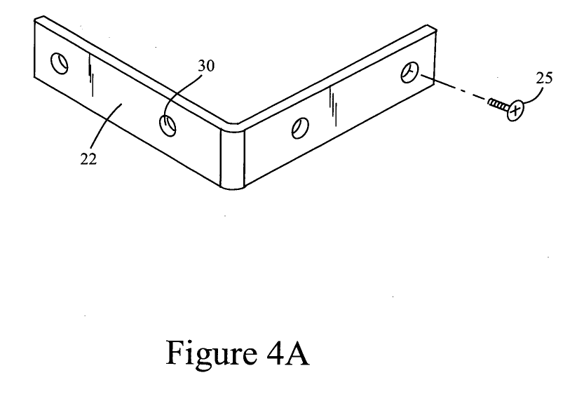

In one embodiment of the present invention, as shown in FIG. 4 the side rails 18 and end rails 19 are associated by, for example, at least one angle clip 22 (FIG. 4A). For example, the angle clip 22 extends between a portion of the first device side 11 and a portion of the second device side 13. The angle clip 22 may be associated with the side rails 18 and end rails 19 by angle clip fasteners 25 which extend through, for example, a fastening portion 30. The angle clip fasteners 25 may be screws, rivets, adhesives, weld material, and/or the like, and the angle clip fastening portion 30 may be, for example, a cavity, or position on the angle clip 22.

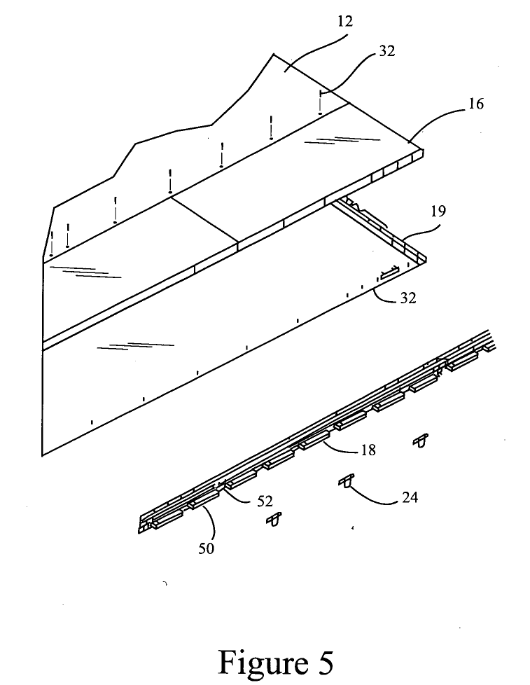

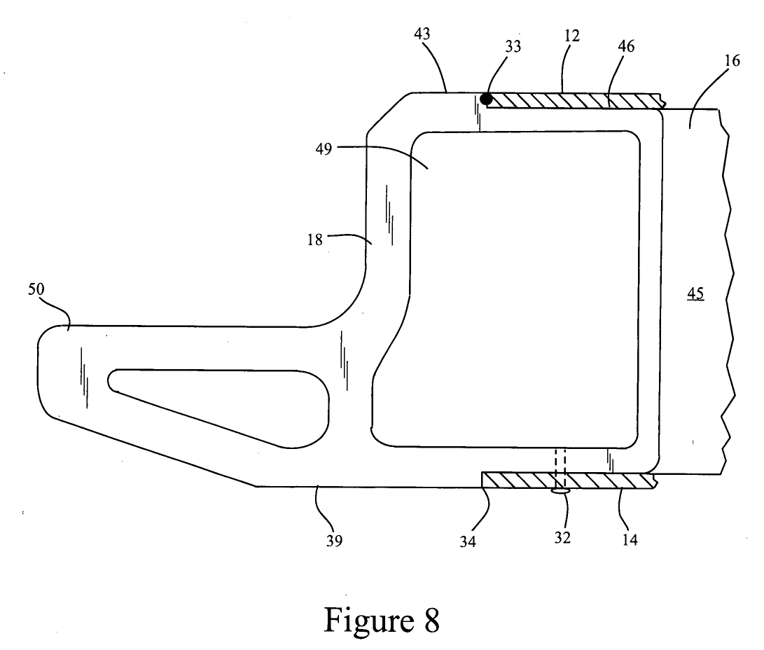

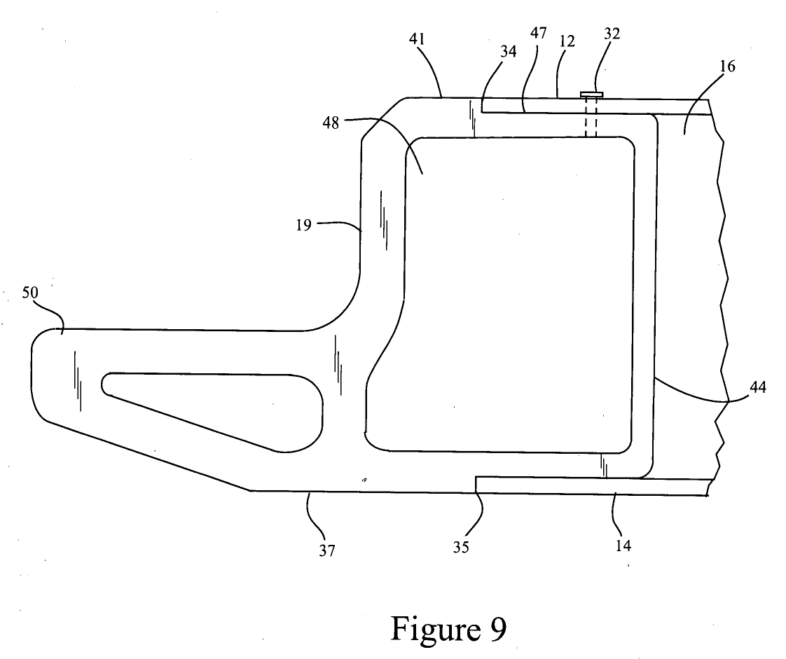

In one embodiment of the present invention, as shown in FIG. 5 the end rails 19 and the side rails 18 are elongate structures having a lip 50 that includes plurality of notches 52. The lip 50 and notches 52 provide surfaces that advantageously cooperate with aerial delivery equipment and/or cargo transportation features. In one embodiment of the present invention, the end rails 19 and the side rails 18 are, for example, associated with the top skin 12 and the bottom skin 14 such that a portion of the top skin and a portion of the bottom skin overlap a portion of the side rail 18 (FIG. 8) and a portion of the end rail 19 (FIG. 9).

In one embodiment of the present invention, as shown in FIG. 5, the side rail 18 and the end rail 19 are associated with a portion of the top skin 12 and a portion of the bottom skin 14. The side rail 18 and the end rail 19 may be associated with the top skin 12 and the bottom skin 14 by adhesive, welding, and/or rivets 32. For example, as shown in FIG. 8, the side rail 18 may include a central cavity 49, a lower step surface 34 in a lower side rail surface 39 and an upper step surface 46 in an upper side rail surface 43. The side rail 18 may also include a core side surface 45 which when, for example, the side rail 18 is associated with the aerial delivery pallet 10, the core side surface 45 of the side rail is adjacent to the core 16. The top skin 12 may be associated with the upper step surface 46 by, for example, adhesive, rivets 32 and/or weld material 33. For example, the bottom skin 14 may be associated with the lower step surface 34 by, for example, adhesive, rivets 32 and/or weld material 33.

In one embodiment of the present invention, for example, as shown in FIG. 9, the end rail 19 may include, a central cavity 48 a lower step surface 35 in a lower end rail surface 37 and an upper step surface 47 in an upper end rail surface 41. The end rail 19 may also include a core side surface 44 which, for example, when the end rail 19 is associated with the aerial delivery pallet 10, the core side surface 44 of the end rail is adjacent, is in contact, and/or otherwise associated with the core 16. The top skin 12 may be associated with the upper step surface 47 by, for example, adhesive, rivets 32 and/or weld material. The bottom skin 14 may be associated with the lower step surface 34 by, for example, adhesive, rivets 32 and/or weld material.

In one embodiment of the present invention, the end rail 19 and/or the side rail 18 may be formed of, or incorporate, plastics, synthetic and/or natural fibers, fabrics, resins, polymers, metals, ceramics, glasses, composites and/or other materials which provide advantageous load bearing and/or resilient properties desirable in aerial delivery equipment. For example, the end rail 19 and/or the side rail 18 may be formed of, or incorporate, aluminum alloy, for example 6061-T6, per ASTM B221, or 6005-T5 per ASTM B221. The end rail 19 and/or the side rail 18 have dimensions of, for example, approximately 88.00 inches and 108.00 long respectively. The end rail 19 and/or the side rail 18 may be approximately 3.50 inch wide and approximately 2.13 inches in height. The end rail 19 and/or the side rail 18 may have various cavities, voids, and/or tubular portions.

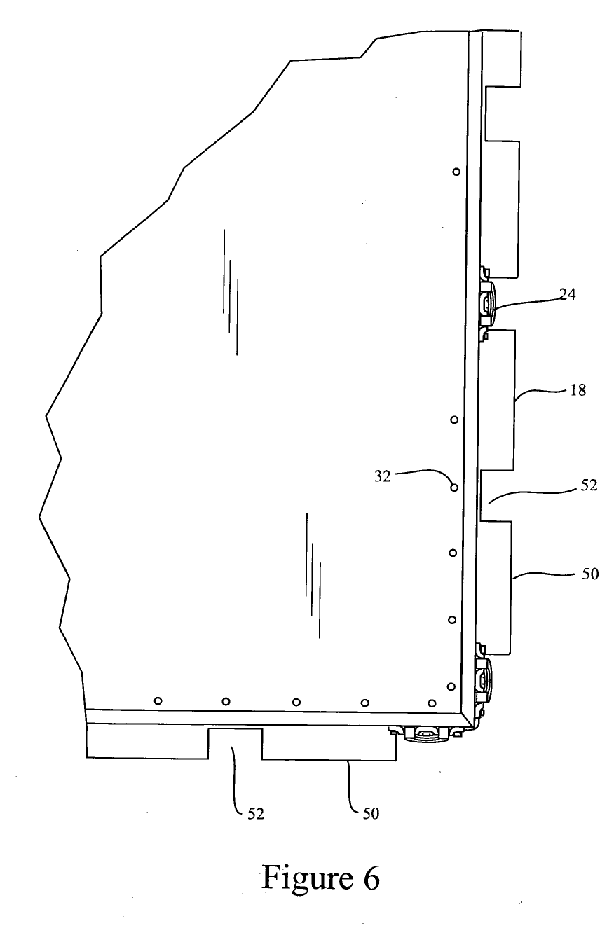

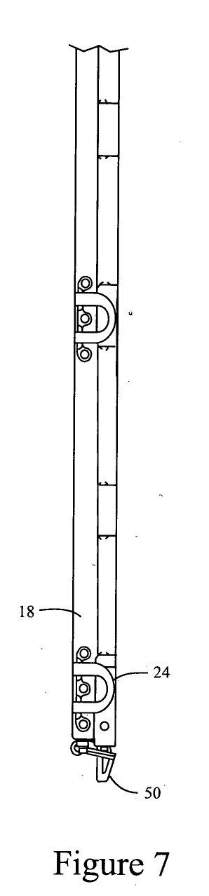

In one embodiment of the present invention, for example as shown in FIGS. 6 and 7, the rails provide a surface for association with tie down rings 24. For example, side rail 18 may be associated with at least one tie down ring 24.

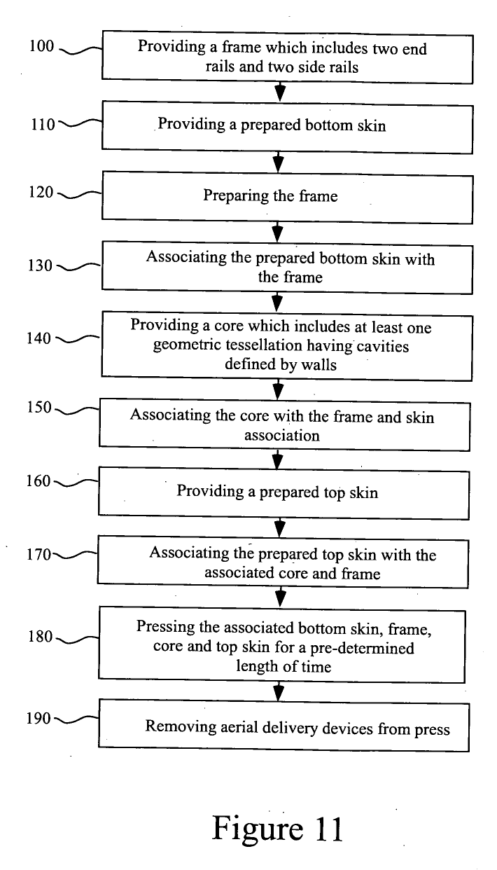

One embodiment of the present invention includes a method of assembling an aerial delivery device. For example, as shown in FIG. 11 a method of assembling an aerial delivery device may include: providing a frame which includes two end rails and two side rails 100; providing a prepared bottom skin 110; preparing the frame 120; associating the prepared bottom skin with the frame 130; providing a core which includes, a geometric arrangement of cells, for example, at least one geometric tessellation having cavities defined by walls 140; associating the core with the frame and skin association 150; providing a prepared top skin 160; associating the prepared top skin with the associated core and frame 170; pressing the associated bottom skin, frame, core, and top skin for a pre-determined length of time 180; and removing the aerial delivery device from press 190.

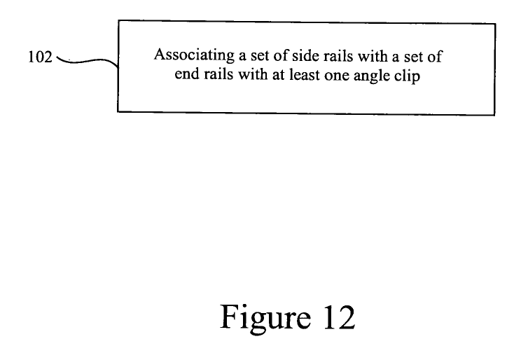

In one embodiment of the present invention, as shown in FIG. 12, the method assembling an aerial delivery device may include associating a set of side rails with a set of end rails, for example, with at least one angle clip 102. For example, each of the angle clips may be riveted, welded, and/or otherwise bonded to a portion of the end rail and a portion of the side rail. It should be noted that, if present, the angle clips can be present, for example, on either or both the exterior and interior corners of the frame.

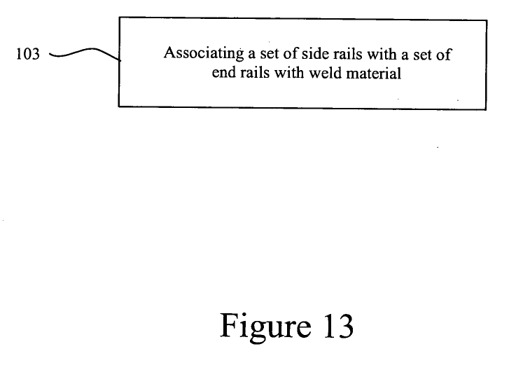

In one embodiment of the present invention, as shown in FIG. 13, the method assembling an aerial delivery device may include: associating a set of side rails with a set of end rails with weld material 103.

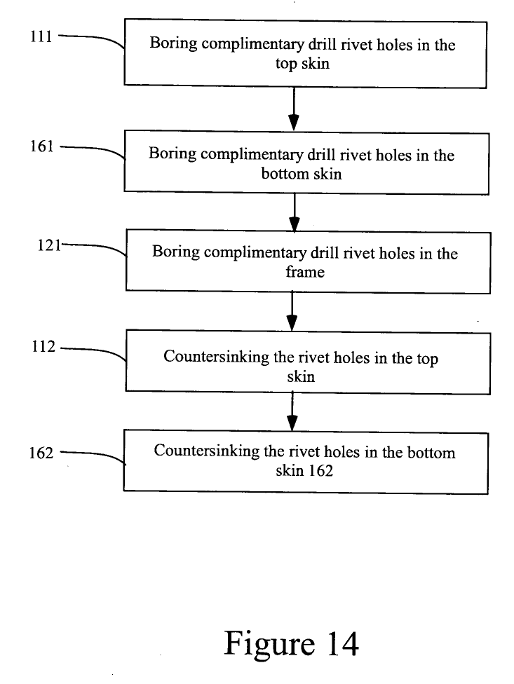

In one embodiment of the present invention, as shown in FIG. 14, the method assembling an aerial delivery device may include, for example, preparing the top skin, the bottom skin, and frame by including the optional steps of: boring complimentary drill rivet holes in the top skin 111, bottom skin 161, and frame 121; and countersinking the rivet holes in the top skin 112 and bottom skin 162.

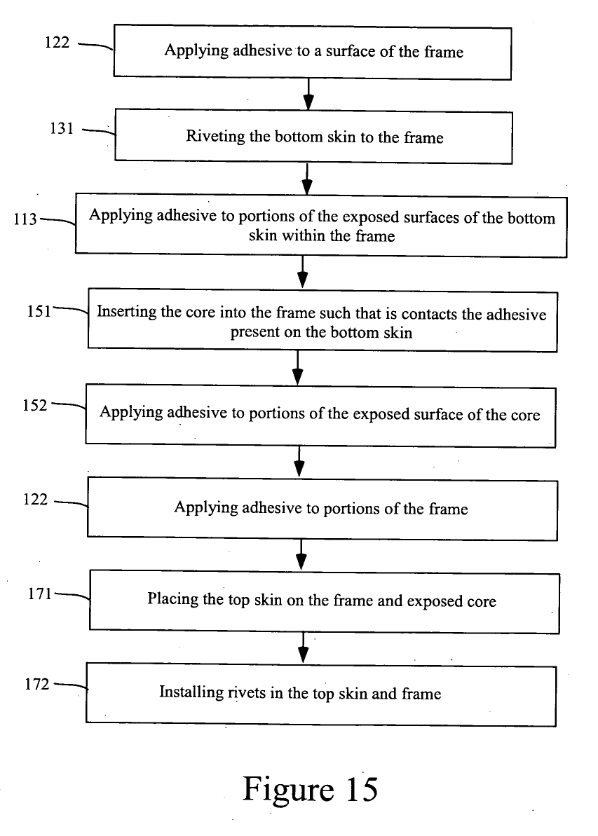

In one embodiment of the present invention, as shown in FIG. 15, the method assembling an aerial delivery device may include, for example, applying adhesive to a surface of the frame 122; riveting the bottom skin to the frame 131; applying adhesive to portions of the exposed surfaces of the bottom skin within the frame 113; inserting the core into the frame such that it contacts the adhesive present on the bottom skin 151; applying adhesive to portions of the exposed surface of the core 152; applying adhesive to portions of the frame 122; placing the top skin on the frame and exposed core 171; and installing rivets in the top skin and frame 172.

In one embodiment of the present invention, preparation of the frame, top skin, core, bottom skin, and/or other elements of the aerial delivery device may include chemical and/or mechanical treatment which advantageously prepares the surface of the element for association with other aerial delivery device elements, for example adhesive association between the top/bottom skin and the core. For example, solvents may be used to remove and/or reduce oils, grease and foreign bodies. Vapour baths can be used in addition for preparation of aerial delivery elements.

In one embodiment of the present invention, preparation of the frame, top skin, core, bottom skin, and/or other elements of the aerial delivery device may include mechanical cleaning. For example, blasting, vapour honing, abrasion with belts, discs, wire brushes and/or emery paper may be used to clean an element surface and/or to increase the bond area of the surface.

In one embodiment of the present invention, the steps of preparing the frame, top skin, core, bottom skin, and/or other elements of the aerial delivery device may include chemical preparation and/or plasma surface treatments. For example, chemical application to the surfaces may change the surface properties of the aerial delivery pallet to advantageously modify the surface energy to enhance, for example the chances of intermolecular interactions. Plasma surface treatment may be used to remove non-desirable material from surfaces via ablation.

In one embodiment of the present invention, preparation of the frame, top skin, core, bottom skin, and/or other elements of the aerial delivery device may include mechanical cleaning.

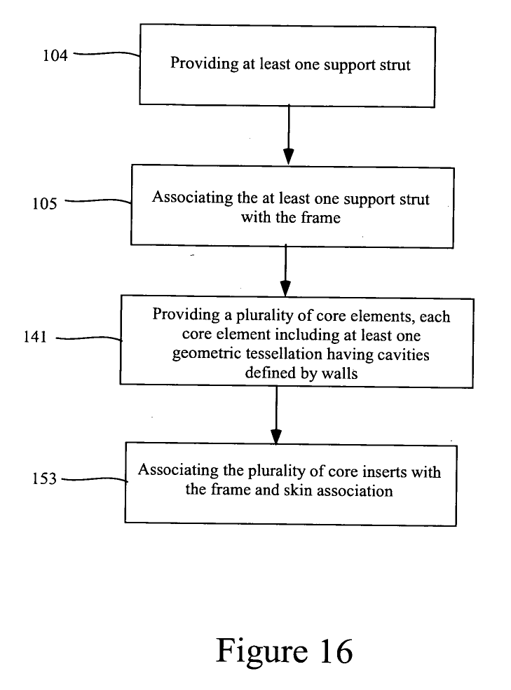

In one embodiment of the present invention, as shown in FIG. 16, the method assembling an aerial delivery device may include, for example, providing at least one support strut 104; associating the at least one support strut with the frame 105; providing a plurality of core elements, wherein, for example, each core element including at least one geometric tessellation having cavities defined by walls 141; and associating the plurality of core inserts with the frame and skin association 153. It should be noted that support struts may be arranged in any advantageous configuration within the frame. For example, the support struts may extend from end rail to end rail; side rail to side rail; end rail to side rail; side rail to support strut, and/or end rail to support strut.

In one embodiment of the present invention, the method assembling an aerial delivery device may include, for example, pressing the associated bottom skin, frame, core, and top skin at a pressure of between approximately 2 pounds per square inch and approximately 10 pounds per square inch for a period of time between approximately 30 minutes to approximately 8 hours. For example, the associated bottom skin, frame, core, and top skin may be pressed at a pressure of approximately 5 pounds per square inch for a period of time approximately 4 hours.

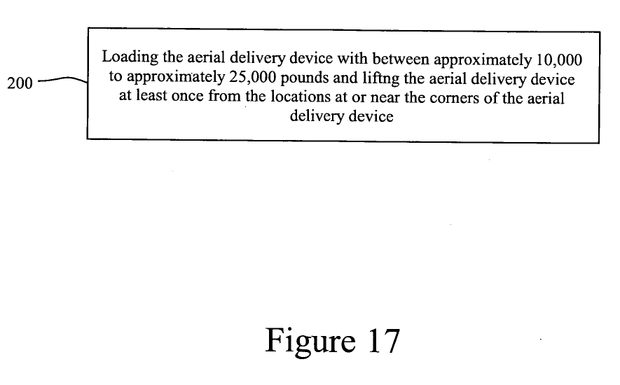

In one embodiment of the present invention, as shown in FIG. 17, the method assembling an aerial delivery device may include, for example, the steps of: testing an aerial delivery by loading the aerial delivery device with between approximately 10,000 to approximately 25,000 pounds, for example, 18,000 pounds and lifting the aerial delivery device at least once from the locations at or near the corners or the ends of the aerial delivery device 200.

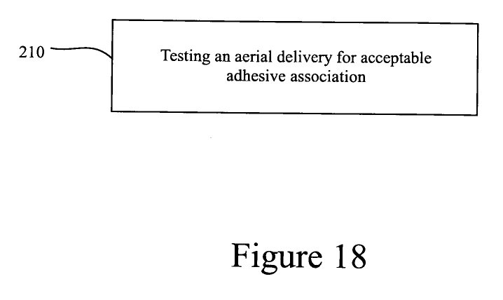

In one embodiment of the present invention, as shown in FIG. 18, the method assembling an aerial delivery device may includes, for example, the steps of: testing an aerial delivery for acceptable adhesive association of, for example, bottom skin, frame, core, and/or top skin association 210 by, for example tap test and/or ultrasonic assessment of the aerial delivery device. It should be noted that testing of acceptable adhesive association may include: detection of adhesive presence; detection of adhesive bond integrity; and/or detection of undesired association between elements of the aerial delivery device.

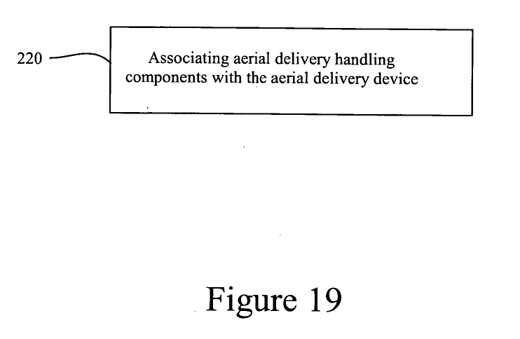

In one embodiment of the present invention, as shown in FIG. 19, the method assembling an aerial delivery device may includes, for example, the steps of: associating aerial delivery handling components with the aerial delivery device, for example, tie down rings, radio frequency identification elements, labels, ID plates, or other like elements. 220.

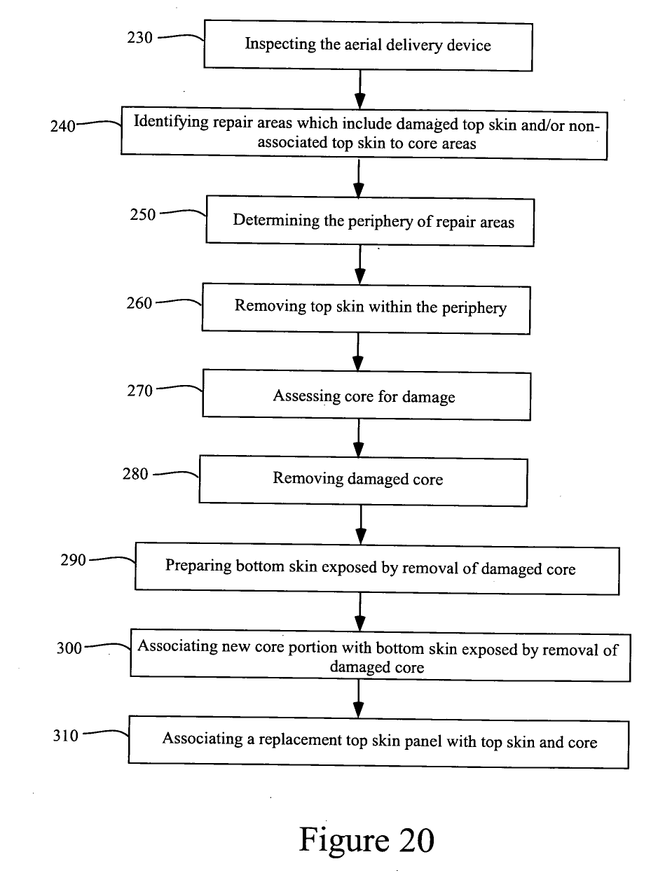

One embodiment of the present invention, as shown in FIG. 20, includes a method of repairing an aerial delivery device. For example, a method of repairing an aerial delivery device with damage to the top skin may include: inspecting the aerial delivery device 230; identifying a repair area or repair areas which include damaged top skin and/or non-associated top skin to core areas 240; determining the periphery of repair areas 250; removing top skin within the periphery of the repair area 260; assessing core for damage 270; removing damaged core 280, for example, cutting or routing out the core can be used to remove core; preparing bottom skin exposed by removal of damaged core 290, for example, preparation techniques and methods used in aerial delivery device assembly may be employed; associating new or replacement core element with bottom skin exposed by removal of damaged core 300; and associating a replacement top skin panel with top skin and at least the replacement core 310.

In one embodiment of the present invention, inspecting the aerial delivery device may include, for example, ultrasonic or tap testing to determine, for example: the integrity of the skin and core association; and/or the presence of adhesive material. In addition, inspecting the aerial delivery device may include: visual and/or tactile inspection of the top skin for buckling, denting, bubbling, penetrations, gouges, or the like.

In one embodiment of the present invention, determining the periphery of the repair area may be accomplished by, for example, ultrasonic or tap testing to determine, for example: the integrity of the skin and core association; and/or the presence of adhesive material. In addition, determining the periphery of the repair area may be accomplished by, for example visual and/or tactile inspection of the top skin for buckling, denting, bubbling, penetrations, gouges, or the like.

In one embodiment of the present invention, removing the top skin may be accomplished by, for example, grinding, routing, and/or cutting the top skin. In addition, areas of the top skin to be removed that are associated with the rails may be unassociated by, for example, drilling out rivets, grinding away weld material; cutting, melting, softening, and/or otherwise weakening adhesive bonding. Furthermore, portions of the top skin may be removed by physical separation aided by, for example, pry bars, cutting elements, or the like.

In one embodiment of the present invention, assessment of core damage may include, for example, visual inspection of the core for areas where: scrim has been torn away; deformation of honeycomb cells; buckling of core material; torn core material; and/or missing, gouged, compressed, or otherwise distorted core material.

In one embodiment of the present invention, associating a replacement top skin includes, for example, placing a new top skin portion over the core within the opening in the top skin created by the step of removing the top skin within the periphery. In addition, patch skin portions may be associated with the new top skin portion and the top skin. For example, patch skin portion may be associated with the new top skin and the top skin such that, for example, gaps between the new top skin and the top skin are covered by the patch skin. The patch skin may be associated with the new top skin and the top skin by, for example, counter sunk rivets, weld material, and/or adhesive.

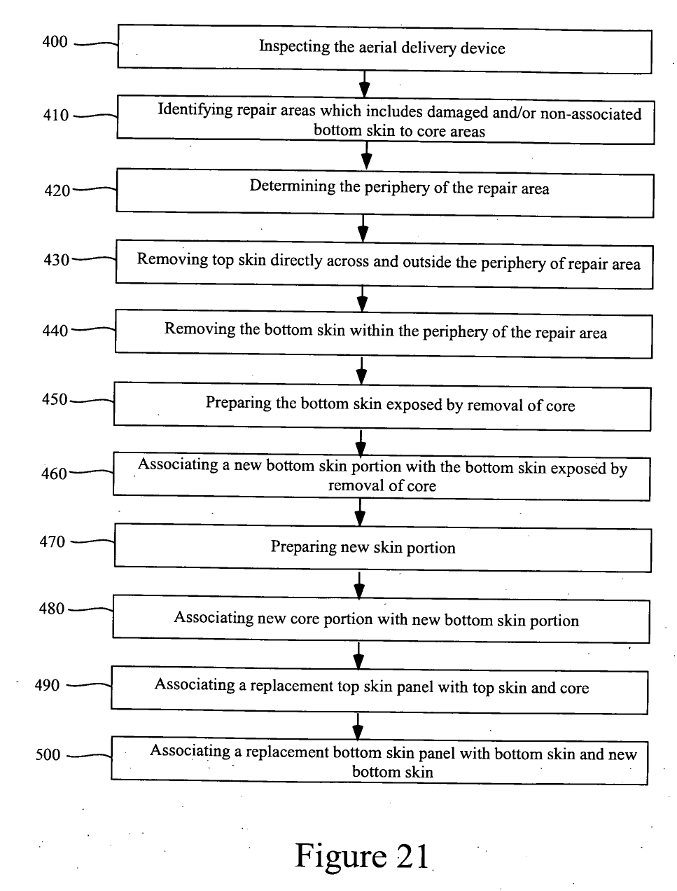

One embodiment of the present invention includes a method of repairing an aerial delivery device. For example, as shown in FIG. 21 a method of repairing an aerial delivery device with damage to the bottom skin may include: inspecting the aerial delivery device 400; identifying repair areas which include damaged and/or non-associated bottom skin to core areas 410; determining the periphery of the repair area 420; removing top skin directly across and outside the periphery of repair area 430; removing the bottom skin within the periphery of the repair area 440; preparing the bottom skin exposed by removal of core 450; associating a new bottom skin portion with the bottom skin exposed by removal of core 460; preparing new skin portion 470; associating new or replacement core element with the new bottom skin portion 480; associating a replacement top skin panel with top skin and core 490; and associating a replacement bottom skin panel with bottom skin and new bottom skin 500.

In one embodiment of the present invention, inspecting the aerial delivery device may include, for example, ultrasonic or tap testing to determine, for example: the integrity of the skin and core association; and/or the presence of adhesive material. In addition, inspecting the aerial delivery device may include: visual and/or tactile inspection of the bottom skin for buckling, denting, bubbling, penetrations, gouges, or the like.

In one embodiment of the present invention, determining the periphery of the repair area may be accomplished by, for example, ultrasonic or tap testing to determine, for example: the integrity of the skin and core association; and/or the presence of adhesive material. In addition, determining the periphery of the repair area may be accomplished by, for example visual and/or tactile inspection of the bottom skin for buckling, denting, bubbling, penetrations, gouges, or the like.

In one embodiment of the present invention, removing the top skin directly across and outside the periphery of the bottom skin repair area includes, for example, determining the dimensions of the periphery of the bottom skin repair area; cutting, grinding, or otherwise removing a portion of the top skin such that the opening in the top skin has a greater dimension than the dimension of the periphery of the bottom skin repair area. This great dimension allows for such things as, for example, the placement of a new bottom skin portion through the opening in the top skin such that the new bottom skin portion can rest on a ledge or shelf which is created by removal of the core from an area approximately equivalent to the dimension of the opening with the greater dimension.

In one embodiment of the present invention, associating a replacement bottom skin panel with the bottom skin and new bottom skin includes, for example, placing a replacement bottom skin portion over the new bottom skin exposed within the opening in the bottom skin which was created by the step of removing the bottom skin within the periphery of the repair area. In addition, addition patch skin portions may be associated with the replacement bottom skin portions and the bottom skin. For example, patch skin portion may be associated with the replacement bottom skin portion and the bottom skin such that, for example, gaps between the replacement bottom skin portion and the bottom skin are covered by the patch skin portion. The patch skin portion may be associated with, for example, counter sunk rivets, weld material, and/or adhesive.

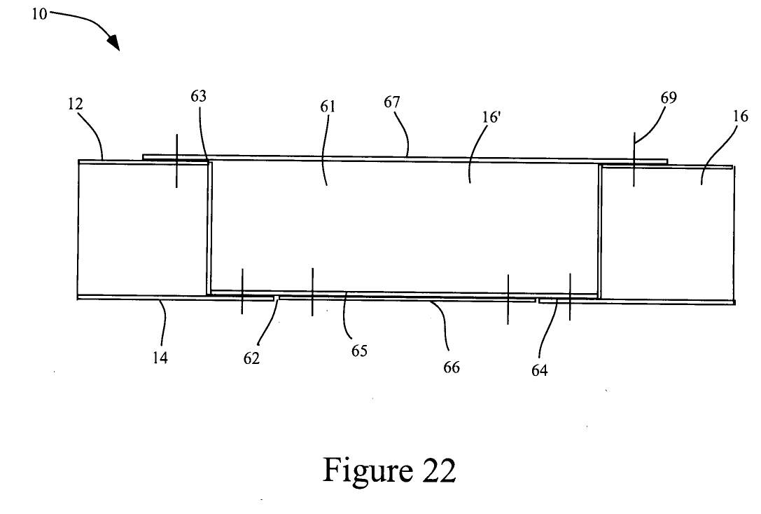

In one embodiment of the present invention, as shown in FIG. 22, a portion of an aerial delivery device 10 may include a modified portion 61, for example a maintained and/or repaired portion such as may be needed to modify a repair area, to provide repair results for an aerial delivery device to be used in an aerial delivery device deployment environment. For example, an environment that included relatively high temperature variations, atmospheric pressure differentials, relatively high energy impacts, relatively severe compression, tensioning, and/or torsional forces, and/or loads of 10,000 pounds or greater within the confines of a surface that is defined by, for example, the dimensions of approximately 82 inches wide by 102 inches long. The modified portion may include a periphery of a repair area 62, an area defined by an opening 63 having a dimension greater than the periphery of the repair area 62, an internal exposed bottom skin portion 64, a new bottom skin portion 65 associated with the exposed bottom skin portion 64, a replacement or new core element 16′ associated with the new bottom skin portion 65, a replacement bottom skin panel 66 associated with the new bottom skin portion 65, a replacement top skin panel 67 associated with, for example, the core 16′ and the top skin 12. In one embodiment of the present invention, fastener material 69 may be included to associate, for example, the replacement top skin panel 67 and the top skin 12, and/or the replacement bottom skin panel 66, the new bottom skin portion 65, and/or the bottom skin 14. It should be understood that any materials or configuration associated with the modified portion and/or the replacement core may be the same or configured as any of the above described cores and/or those within the scope of the present invention. For example, cores 16, 16A, 16B, 16C, 16D, and/or 16E.

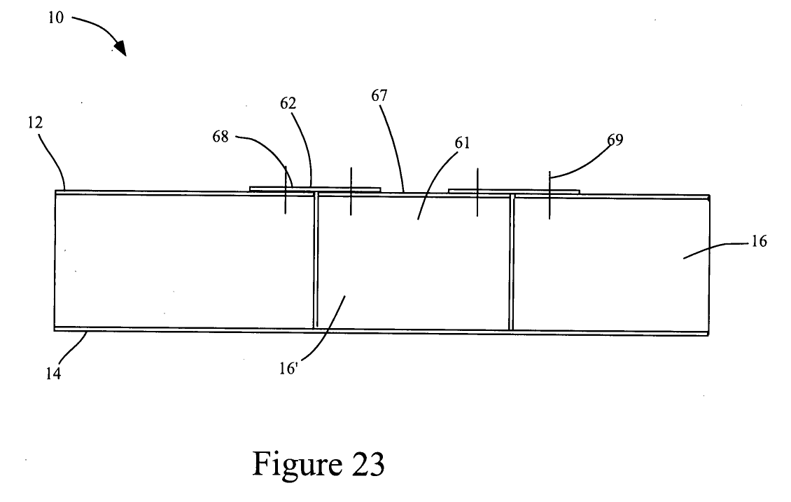

In one embodiment of the present, as shown in FIG. 23, the periphery of the repair area 62 may be the only opening created for the modified portion 61, for example it may be confined to the top skin 12. A replacement top skin 67 may be associated with the core 16′ by inclusion of patch skin portions 70 and/or fastening material 69. It should be understood that the fastening material may include, for example, adhesive, weld material, rivets, screws, and/or the like. It should be understood that any materials or configuration associated with the modified portion and/or the replacement core may be the same or configured as any of the above described cores and/or those within the scope of the present invention. For example, cores 16, 16A, 16B, 16C, 16D, and/or 16E.

While various embodiments of the foregoing invention have been set forth for purposes of illustration, the foregoing descriptions of the embodiments are not limitations to the invention herein. Accordingly, various modification, adaptations, combinations, and alternatives may occur to one skilled in the art without departing from the spirit and the scope of the present invention and are thus part of the invention herein.

1. An aerial delivery device comprising:
a frame, a top skin, a bottom skin; and
a core associated with the top skin, and bottom skin, said core having a geometric arrangement of cells, said cells having a cavity defined by walls which extend at least partially between the top skin and the bottom skin.

2. The aerial delivery device of claim 1, wherein the frame comprises a pair of end rails and a set of side rails; at least one support strut that extends between at least the pair of end rails; and wherein said core is present in at least two pieces.

3. The aerial delivery device of claim 1, wherein the core includes an external layer.

4. The aerial delivery device of claim 3, wherein the geometric arrangement of cells includes a polypropylene honeycomb, and said external layer includes a polyester scrim which is associated with to the polypropylene honeycomb, said core being associated with the top skin and the bottom skin by a structural adhesive that adhesively associates the polyester scrim with the top skin and the bottom skin.

5. The aerial delivery device of claim 2, wherein each of the end rails is associated with each of the side rails by angle clips, and wherein the support strut is associated with the end rails by angle brackets; and said geometric arrangement of cells includes a polypropylene honeycomb with a polyester scrim which is associated to the polypropylene honeycomb, said core being associated with the top skin and the bottom skin by a structural adhesive that adhesively associates the polyester scrim with the top skin and the bottom skin.

6. The aerial delivery device of claim 5, wherein each of the end rails and each of the side rails are formed of aluminum alloy, each of the end rails and each of the side rails include a lip with a plurality of notches and at least one tie down ring.

7. The aerial delivery device of claim 6, wherein a load of approximately 18,000 pounds is in contact with the top skin and the aerial delivery device is supported entirely by a first device end and a second device end without device damage.

8. The aerial delivery device of claim 1, wherein the core includes at least a first core element and a second core element, wherein at least the first core element includes a geometric tessellation of cells having a hexagonal configuration.

9. The aerial delivery device of claim 8, wherein an internal layer is present intermediate the first core element and the second core element.

10. The aerial delivery device of claim 8, wherein an internal layer is present intermediate the first core element and the second core element, and wherein the core includes at least one exterior layer.

11. The aerial delivery device of claim 1, further including a modified portion having a periphery of a repair area; an area defined by an opening having a dimension greater than the periphery of the repair area; an internal exposed bottom skin portion; a new bottom skin portion associated with the exposed bottom skin portion; a replacement core element associated with the new bottom skin portion; a replacement bottom skin panel associated with the new bottom skin portion; and a replacement top skin panel associated with the replacement core element and the top skin.

12. The aerial delivery device of claim 1, further including a replacement top skin portion associated with a replacement core element, said replacement top skin portion being associated with the top skin by at least one patch skin portion.

13. An aerial delivery device comprising:
a core having a plurality of geometric cavities defined by a wall, said wall extends in a substantially perpendicular direction relative to a top skin and a bottom skin;
a frame which includes a pair of end rails and a pair of side rails, said frame providing a substantially contiguous boarder around a perimeter of the core; and
an association between portions of the top skin, the bottom skin, the frame, and the core.

14. The aerial delivery device of claim 12, wherein said side rails and end rails are associated by angle clips; said geometric cavities are defined by walls which are substantially plastic and are configured as a honeycomb; an external layer included with the core; a support strut substantially contained within an aerial delivery device interior and associated with at least a core side surface of the end rails; and wherein the association between portions of the top skin, the bottom skin, the frame, and the core are adhesive.

15. The aerial delivery device of claim 12, wherein said geometric cavities are defined by walls which are substantially configured in tessellated arrangement; and wherein the association between portions of the top skin, the bottom skin, the frame, and the core are adhesive.

16. The aerial delivery device of claim 12, further including a modified portion having a periphery of a repair area; an area defined by an opening having a dimension greater than the periphery of the repair area; an internal exposed bottom skin portion; a new bottom skin portion associated with the exposed bottom skin portion; a replacement core element associated with the new bottom skin portion; a replacement bottom skin panel associated with the new bottom skin portion; and a replacement top skin panel associated with the replacement core element and the top skin.

17. The aerial delivery device of claim 12, further including a replacement top skin portion associated with a replacement core element, said replacement top skin portion being associated with the top skin by at least one patch skin portion.

18. The aerial delivery device of claim 12, further including an RFID element, said core includes a structural element associated with at an least one core element.

19. An aerial delivery device assembly method comprising:
providing a frame which includes two end rails and two side rails;
providing a prepared bottom skin;
preparing the frame;
associating the prepared bottom skin with the frame;
providing a core which includes a geometric arrangement of cells having cavities defined by walls;
associating the core with the frame and bottom skin association such that the cell walls extend in a direction substantially away from the bottom skin;
providing a prepared top skin;
associating the prepared top skin with the associated core and frame;
pressing the associated bottom skin, frame, core, and top skin for a pre-determined length of time; and
removing the aerial delivery device from press.

20. An aerial delivery device repair method comprising:
inspecting an aerial delivery device;
identifying repair areas;
determining a periphery of the repair areas;
removing a first side skin within the periphery of the repair areas;
removing a second side skin directly across from and outside the dimensions of the first side skin periphery of the repair area if necessary;
removing a portion of the core;
preparing skin exposed by removal of core;
associating a replacement core portion with bottom skin exposed by removal of damaged core; and
associating a replacement top skin panel with top skin and core.
